(19) United States
(12) Patent Application Publication
(10) Pub. No.: US 2005/0207875 A1
(43) Pub. Date: Sep. 22, 2005

(54) Blade of wafer transfer robot, semiconductor manufacturing equipment having a transfer robot comprising the same, and method of aligning a wafer with a process chamber

(76) Inventor: Jong-Jun Kim, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/075,910

(22) Filed: Mar. 10, 2005

(30) Foreign Application Priority Data
Mar. 18, 2004 (KR) 2004-18429

(51) Int. Cl. B65G 1/00

(52) U.S. Cl. 414/217

(57) ABSTRACT

A transfer robot of semiconductor manufacturing equipment has the ability to sense the relative position of a wafer transferred by the robot so that the wafer can be aligned for processing. The semiconductor manufacturing equipment includes at least one load lock chamber, a transfer chamber in which the transfer robot is disposed, and at least one process chamber, e.g., an etching chamber and a stripping chamber. The transfer robot transfers wafers from a load lock chamber directly to the etching chamber through the transfer chamber, from the etching chamber to the stripping chamber, and from the stripping chamber to a load lock chamber. The blade of the transfer robot has an array of contact sensors by which the relative position of the wafer can be sensed such that a separate orienting device is not necessary. Hence, the etching process can be carried out in a relatively short time.

### BACKGROUND OF THE INVENTION

1. Field of the Invention

The present invention relates to semiconductor manufacturing equipment. More particularly, the present invention relates to wafer sensing apparatus used to check whether wafers are aligned or oriented properly as the wafers progress through an etching process.

2. Description of the Related Art

In general, a semiconductor device is manufactured by performing several main processes on a silicon wafer, such as oxidation, masking, photolithography, etching, diffusion and lamination processes. Also, the manufacturing of semiconductor devices typically entails carrying out several auxiliary processes, e.g., washing, drying and inspection processes, before/after the main processes. Of these processes, the photolithography and etching processes are particularly important as they are used to form a pattern on a wafer. In the photolithography process, the wafer is coated with photoresist having a photosensitivity, and the photoresist is exposed and developed such that the photoresist is patterned. Then the etching process is performed using the patterned photoresist as a mask, thereby providing a layer underlying the photoresist with physical characteristics based on the pattern.

The etching process may be largely classified as wet etching or dry etching. Wet etching may be performed by soaking a wafer in a tub of chemicals capable of effectively removing an uppermost layer of a wafer, by spraying the chemicals onto a surface of a wafer, or by dispensing the chemicals onto a wafer held at a predetermined inclination.

Dry etching includes plasma etching in which the etching is carried out by gas in an excited state, ion beam etching in which the etching is carried out using a beam of ions, and reactive ion etching. In reactive ion etching, etching gas is induced into a reaction vessel, is then ionized using power at a radio frequency (RF power), and is then directed onto a surface of the wafer, thereby physically and chemically removing an uppermost layer of the wafer. Reactive ion etching is characterized as being easy to control, and as being capable of forming patterns having a critical dimension of about 1 μm at a high rate of productivity.

Factors to be considered in obtaining uniformity in the patterns formed using reactive ion etching include: the thickness and density of the layer to be etched, the energy and temperature of the etching gas, the adhesion of the photoresist to the layer to be etched, the surface state of the wafer, and the uniformity of the etching gas. Also, the radio frequency (RF) is one of the most important parameters for quality control purposes, and can be controlled directly and easily in practice.

Semiconductor manufacturing equipment for performing a dry etching process, such as reactive ion etching, typically includes a plurality of process chambers, and a wafer transfer robot having a blade for transferring wafers to and from the process chambers. Also, the equipment may have a system for determining whether a wafer is present on the blade of the wafer transfer robot, and a system for detecting and correcting the relative position of a wafer. Semiconductor manufacturing equipment of this type is disclosed in U.S. Pat. No. 5,980,194.

FIG. 1 illustrates conventional semiconductor manufacturing equipment for performing an etching process. Referring to FIG. 1, the equipment includes first and second load lock chambers 10 and 12 each having a shelf onto which a robot (not shown) transfers wafers, a transfer chamber 30, a transfer robot 32 disposed in the transfer chamber 30, first and second orienting chambers 14 and 16, and first, second, third and fourth process chambers 18, 20, 22 and 24.

The transfer robot 32 operates to transfer the wafers from the load lock chambers 10 and 12 to the first and second orienting chambers 14 and 16, to transfer wafers from the first and second orienting chambers 14 and 16 to the first second process chambers 18 and 20, to transfer processed wafers from the first and second process chambers 18 and 20 to the third and fourth process chambers 22 and 24, and to transfer processed wafers from the third and fourth process chambers 24 to the first and second load lock chambers 10 and 12. The first and second orienting chambers 14 and 16 sense the relative position of the wafers and rotate the wafers transferred thereto by the transfer robot 32 so that the wafers are aligned with respect to the first and second process chambers 18 and 20. An etching process may be performed in the first and second process chambers 18 and 20, whereas a stripping process may be performed in the third and fourth process chambers 22 and 24.

FIG. 2 schematically illustrates an internal structure of the first and second orienting chambers 14 and 16. Referring to FIG. 2, each orienting chamber includes a chuck 1 having a through-rod 1a, a vacuum rotator 2 extending within the through-rod 1a of the chuck 1 and which moves upward and downward together with the chuck 1, a stepping motor (not shown) for rotating the vacuum rotator 2 by predetermined increments, and a laser sensor 3 disposed to one side of the chuck 1 and which senses the wafer as the vacuum rotator 2 rotates the wafer. The laser sensor 3 has a light emitter 3a and a light receptor 3b disposed directly across from each other at the outer periphery of the chuck 1.

The operation of the conventional semiconductor manufacturing equipment will now be described.

Wafers are transferred one by one from a load port (not shown) to the shelves of the first and second load lock chambers 10 and 12 by an ATM (Asynchronous Transfer Mode) robot (also not shown). When the transfer of wafers to the first and second load lock chamber 10 or 12 is completed, the doors of the first and second load lock chambers are closed, and air is extracted therefrom until a vacuum state is created. The vacuum state prevents contaminants from entering the load lock chambers. Then, the transfer robot 32 transfers the wafers from the shelf of the first or second load lock chamber 10 or 12 to the chuck 1 of the first orienting chamber 14 or second orienting chamber 16. The first or second orienting chamber 14 or 16 rotates the wafer transferred thereto while the laser sensor 3 senses the wafer. Specifically, the light emitter 3a of the laser sensor 3 emits light towards the edge of the wafer. Light that impinges the wafer is reflected and thus, is not received by the light receptor 3b. On the other hand, if no portion of the wafer exists beneath the light emitter 3a as would occur when the wafer is offset form its desired position, the light receptor 3b receives the light emitted by the light emitter 3. Accordingly, the relative position of the wafer is sensed. Coordinates of the wafer sensed by the laser sensors 3 of the first and second orienting chambers 14 and 16 are transferred to a robot controller (not shown). A main controller reads the coordinates, compares them with reference alignment data, and sends position compensation data to a robot controller. The robot controller controls the transfer robot 32 to compensate for the position of the wafer in the first or second orienting chamber 14 or 16 so that the robot transfers the wafer to first or second process chamber 18 or 20 while the wafer is oriented correctly for processing. Next, the main controller controls the etching process performed in the first or second process chamber 18 or 20. When the etching process is completed, the main controller commands the robot controller to drive the transfer robot 32 and thereby transfer the processed wafers from the first or second process chamber 18 or 20 to a third or fourth process chamber 22 or 24. A stripping process is then performed in the third or fourth process chamber 22 or 24 under the control of the main controller. Once the stripping process is completed in the third or fourth process chamber 22 or 24, the main controller controls the transfer robot 32 to transfer the wafer to a cooling chamber (not shown) in which the wafer is allowed to cool. Then the cooled wafer is transferred back to the first or second load lock chamber 10 or 12.

However, such a conventional semiconductor manufacturing apparatus transfers the wafers to dedicated orienting chambers, the relative positions of the wafers are sensed in the orienting chambers in preparation for etching process, and then the wafers are aligned with the process chambers in which the etching process is to take place. Accordingly, the processing time is rather excessive. That is, the use of the orienting chambers limits the productivity of the etching process.

### SUMMARY OF THE INVENTION

Accordingly, an object of the present invention is to provide semiconductor manufacturing equipment in which the processing time, e.g., the time required to complete an etching process, is relatively short.

Another object of the present invention is to provide low cost semiconductor manufacturing equipment in which wafers can nonetheless be reliably aligned for processing.

According to one aspect of the present invention, semiconductor manufacturing equipment includes a load lock chamber having a shelf on which wafer are loaded, a transfer chamber, a process chamber, and a transfer robot disposed in the transfer chamber and which can sense the relative position of a wafer supported thereby. Preferably, the semiconductor manufacturing equipment includes two load lock chambers, and several process chambers including an etching chamber in which wafers are etched, and a stripping chamber in which material such as photoresist is stripped from the wafer.

According to another aspect of the invention, the transfer robot has a blade including a plate configured to support a wafer, and an array of contact sensors spaced from one another along the plate of the blade. Each of the contact sensors is actuated when a portion of the wafer rests on the plate at the location of the sensor. Preferably, the contact sensors are arrayed across the entire surface of the plate on which the wafer is supported.

According to still another aspect of the invention, a method for use in the fabricating of a semiconductor device includes loading a wafer onto a shelf of a load lock chamber, subsequently lifting the wafer from the shelf of load lock chamber with a blade of a transfer robot disposed in a transfer chamber, and sensing the relative position of the wafer while the wafer is supported by the blade. At this time, coordinate data indicative of the relative position of the wafer is generated. Then the transfer robot is controlled based on the coordinate data to transfer the wafer supported by the blade from the load lock chamber directly through the transfer chamber to a process chamber. Accordingly, the wafer is aligned with the process chamber. Subsequently, the wafer is processed, e.g., etched, in the process chamber. Next, the transfer robot transfers the robot to another process chamber so that the wafer can be stripped, for example. Finally, the wafer is transferred by the transfer robot to a load lock chamber.

### BRIEF DESCRIPTION OF THE DRAWINGS

The present invention will become more fully understood from the detailed description that follows as made with reference to the accompanying drawings, wherein:

FIG. 1 is a schematic diagram of conventional semiconductor manufacturing equipment;

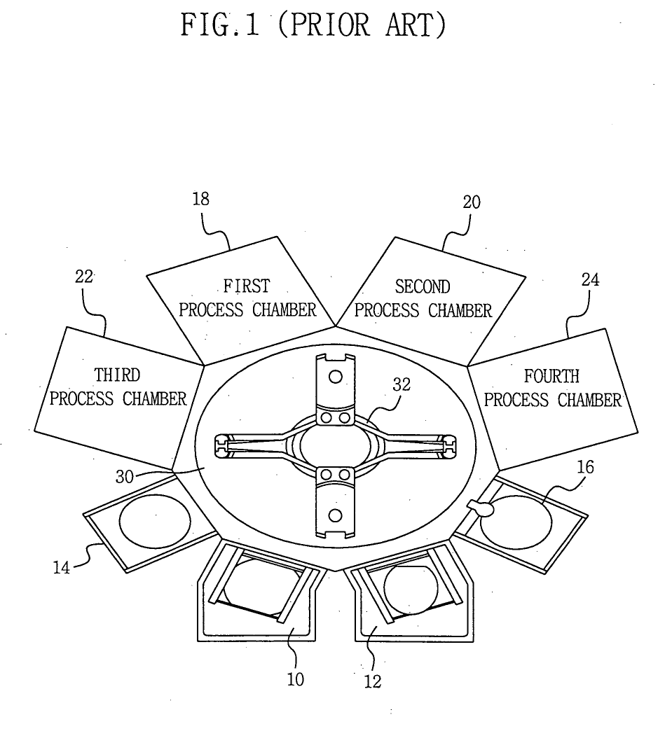

FIG. 2 is a perspective view of an internal structure of the orienting chambers of the equipment shown in FIG. 1;

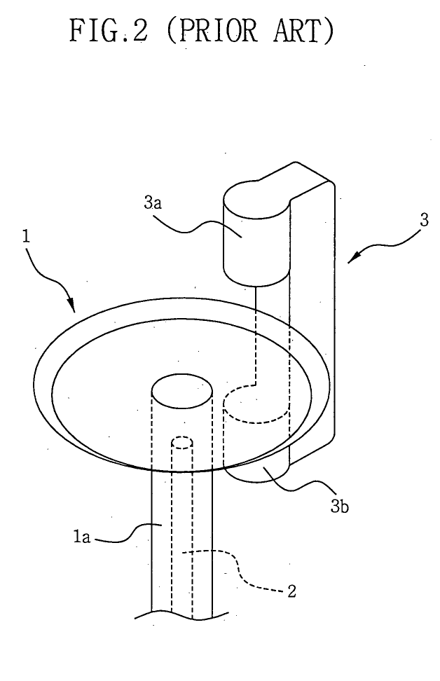

FIG. 3 is a schematic diagram of semiconductor manufacturing equipment according to the present invention;

FIG. 4 is a plan view of a blade of a transfer robot disposed within a transfer chamber of the semiconductor manufacturing equipment according to the present invention;

FIG. 5 is a side view of a section of the blade shown in a state in which a wafer is disposed on the blade; and

FIG. 6 is a diagram illustrating the path along which a wafer to be etched is transferred in the semiconductor manufacturing equipment according to the present invention.

### DETAILED DESCRIPTION OF THE PREFERRED EMBODIMENTS

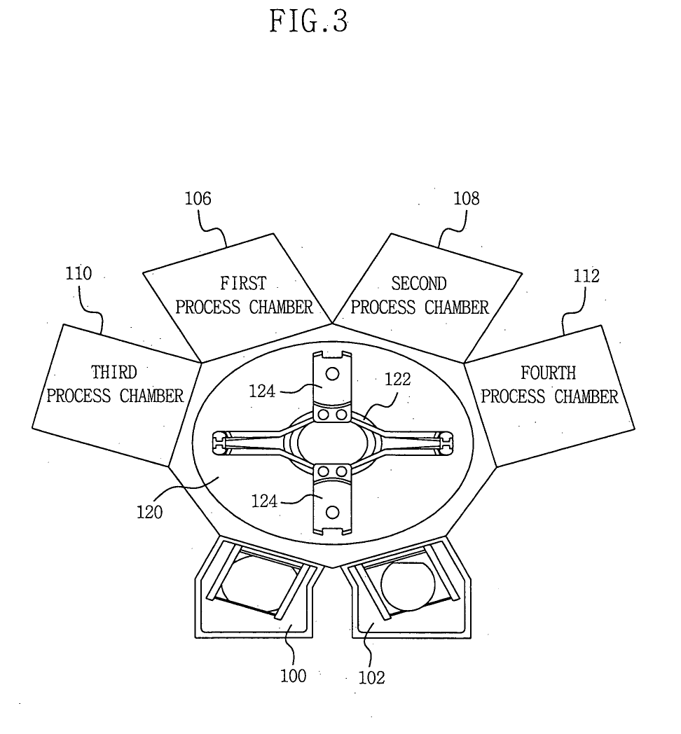

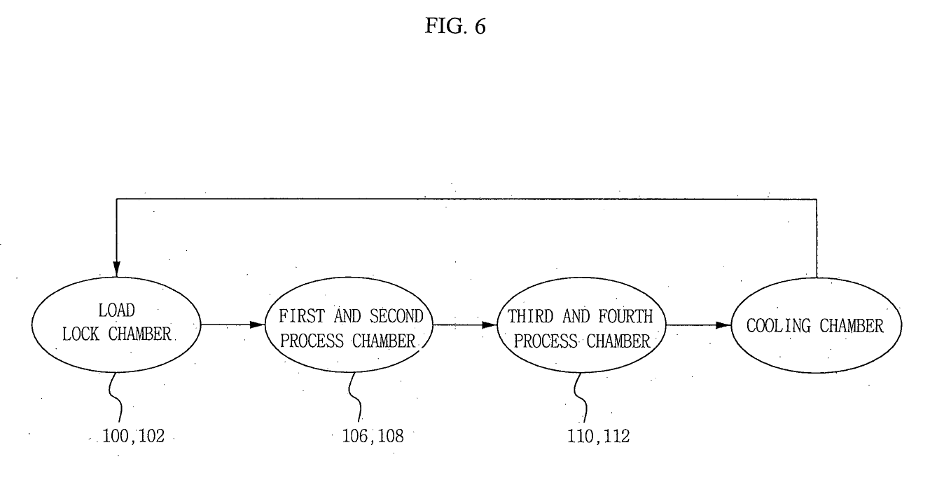

The present invention will now be described in detail with reference to FIGS. 3 to 6. However, a detailed description of those functions and systems which are well known in semiconductor manufacturing equipment of this kind has been omitted for purposes of brevity.

Referring first to FIG. 3, the semiconductor manufacturing equipment includes first and second load lock chambers 100 and 102 that each have a shelf on which wafers are accumulated, a transfer chamber 120 to which the load lock chambers 100 and 102 are connected, a transfer robot 122 disposed in the transfer chamber 120, first and second process chambers 106 and 108 in which the wafers are processed, e.g., etched, and third and fourth process chambers 110 and 112 in which wafers processed in the first and second process chambers 106 and 108 are processed. For example, in the third and fourth process chambers 110 and 112 the wafers may be subjected to a stripping process, such as ashing, in which a photoresist pattern is removed from the wafers.

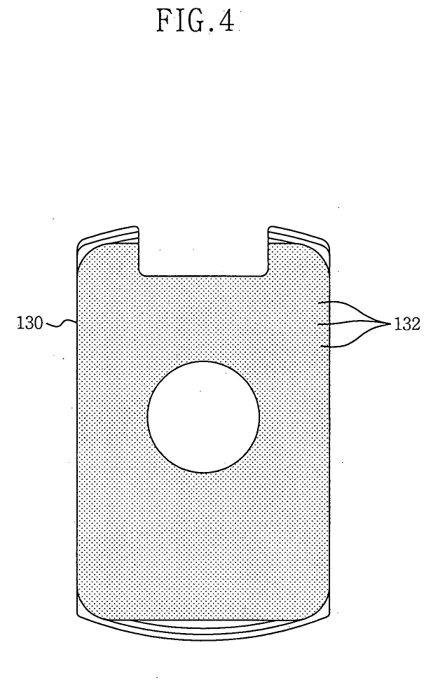

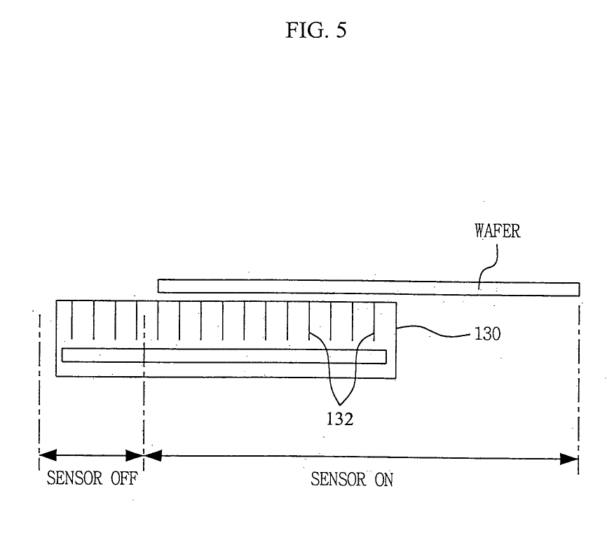

Referring to FIG. 4, the transfer robot 122 has a pair of blades 124 each configured to support and transfer a wafer, and each equipped to sense the relative position of a wafer supported thereon. More specifically, each blade 124 includes a blade plate 130 on which a wafer is supported, and a plurality of contact sensors 132 which are arrayed at uniform intervals on the blade plate 130 to sense for portions of a wafer on the blade plate 130. As shown FIG. 4, the contact sensors 132 are disposed across the upper surface of the blade plate 130 at each of the given intervals from one side thereof to the other (left to right in the figure), and preferably, are provided over the entirety of the upper surface of the blade plate 132 upon which the wafer can rest. FIG. 5 illustrates on/off states of the contact sensors 132 when a wafer is disposed on a blade plate 130 of the transfer robot 122.

The operation of the semiconductor manufacturing equipment will now be described in detail with reference to FIGS. 3 to 6.

Wafers accumulated in a load port are transferred one by one by an ATM robot to the shelves of the first and second load lock chambers 100 and 102. Once the transfer of wafers to the first or second load lock chamber 100 or 102 is completed, a door of the first or second load lock chamber 100 and 102 is closed, and the pressure therein is reduced until a vacuum prevails within the chamber. The vacuum state prevent impurities, i.e., contaminants, from entering the load lock chamber. Then, a blade 124 of the transfer robot 122 lifts up a wafer from the shelf of the first or second load lock chamber 100 or 102. Subsequently, the transfer robot 122 withdraws the wafer on the blade 124 from the first load lock chamber 100 or second load lock chamber 102, and rotates to transfer the wafers to the first or second process chamber 106 or 108. During this time, the transfer robot 122 senses the relative position of the wafer on the blade 124 using the contact sensors 132. As shown in FIG. 5, those contact sensors 132 contacted by portions of the wafer supported by the blade plate 130 assume an “on” state, and whereas those contact sensors 132 not contacted by the wafer assume an “off” sate. Coordinates of the wafer, indicative of the relative position of the wafer as sensed by the contact sensors 132, are transferred to a main controller (not shown). The main controller reads this coordinate data, compares it with reference alignment data, and based on this comparison sends position compensation data to the controller of the transfer robot 122. The robot controller uses the compensation data to compensate for any mis-positioning of the wafer as the transfer robot 122 transfers the wafer to the first or second process chamber 106 or 108. For example, as illustrated in FIG. 5, if a wafer is offset from a reference position by 2 mm to the right, as sensed by the contact sensors 132 of the blade 124, the main controller instructs the robot controller to drive the transfer robot 122 an additional 2 mm to the left when the wafer is transferred to the first or second process chamber 106 or 108.

Then, the main controller controls the etching process carried out in the first or second process chamber 106 or 108. Once the etching process is completed, the main controller instructs the robot controller to drive the transfer robot 122 such that the wafer etched in the first or second process chamber 106 or 108 is transferred to the third or fourth process chamber 110 or 112. A stripping process is performed in the third or fourth process chamber 110 or 112 under the control of the main controller. Once the stripping process is completed, the main controller instructs the transfer robot 122 to deliver the wafer to a cooling chamber (not shown). The wafer is cooled in the cooling chamber. Finally, the wafer is returned by the transfer robot 122 to the first or second load lock chamber 100 or 102.

As described above, the relative position of a wafer is sensed by a blade of the transfer robot as the wafer is being transferred by the robot to a process chamber of semiconductor manufacturing equipment. Thus, the equipment does not require an orienting chamber to align the wafers with the process chamber. Accordingly, the time required to transfer the wafer is relatively short, whereby the overall process can be carried out with a high degree of productivity. In addition, another etching chamber can take the place of the orienting chamber in the conventional semiconductor manufacturing equipment, thereby further enhancing the productivity of the process and minimizing manufacturing costs.

Finally, variations of and modifications to the preferred embodiments of the present invention will be apparent to those skilled in the art. Accordingly, these and other changes and modifications are seen to be within the true spirit and scope of the invention as defined by the appended claims.

1. Semiconductor manufacturing equipment comprising:
a load lock chamber;
a transfer chamber to which the load lock chamber is connected;
a process chamber connected to the transfer chamber and in which a wafer is processed; and
a transfer robot disposed in said transfer chamber and having a working envelope encompassing the load lock and process chambers such that the transfer robot transfers wafers between the load lock and process chambers, said transfer robot comprising a blade having a plate on which a wafer is supported during its transfer by the robot, and position sensing means for sensing the relative position of a wafer on the plate of the blade.

2. The semiconductor manufacturing equipment of claim 1, wherein said position sensing means comprises an array of contact sensors spaced from one another by uniform intervals across the plate of the blade of the transfer robot.

3. A blade of a wafer transfer robot, comprising:
a plate configured to support a wafer; and
an array of contact sensors spaced from one another by uniform intervals across a surface of the plate, each of the contact sensors being actuated when a portion of wafer rests on the plate at the location of the sensor such that the relative position of a wafer supported on the plate can be sensed.

4. A method for use in the fabricating of a semiconductor device, comprising:
loading a wafer onto a shelf in a load lock chamber;
evacuating the load lock chamber;
subsequently lifting the wafer from the shelf of load lock chamber with a blade of a transfer robot disposed in a transfer chamber, the blade including a plate on which the wafer is supported;
while the wafer is supported on the plate of the blade, sensing the relative position of the wafer, and generating coordinate data indicative of the relative position;
controlling the transfer robot, based on the coordinate data, to transfer the wafer supported by the blade from the load lock chamber directly through the transfer chamber to a process chamber; and
subsequently processing the wafer in the process chamber.

5. The method of claim 4, wherein the process chamber is an etching chamber, and said processing comprises etching the wafer in the etching chamber.
